(19) United States
(12) Patent Application Publication
(10) Pub. No.: US 2008/0277503 A1
(43) Pub. Date: Nov. 13, 2008

(54) Flow limiting bottle cap

(76) Inventor: David L. Griffin, O'Fallon, MO (US)

Correspondence Address: CHARLES C. MCCLOSKEY, 763 S. NEW BALLAS ROAD STE. 170, ST. LOUIS, MO, 63141, US

(21) Appl. No.: 12/154,925

(22) Filed: May 28, 2008

Related U.S. Application Data
(63) Continuation-in-part of application No. 09/288,739, filed on Apr. 7, 1999, now abandoned.
Application No. 09/288,739 is a continuation-in-part of application No. 09/284,345, filed on Apr. 14, 1999, now Pat. No. 6,129,295.

(51) Int. Cl. B05B 9/01; B67D 3/00

(52) U.S. Cl. 239/525; 222/519

(57) ABSTRACT

The flow limiting bottle cap secures to a container having a threaded neck and allows a user to select an open or a closed position without removing the cap from a container. Additionally fluid from within a container, when poured, forms multiple separate streams but not a large gusher. The cap provides a pattern of holes for passing of fluid. The cap opens by raising an upper portion and closes by lowering the upper portion or by rotating the upper portion to expose the holes and closing by rotating oppositely to block the holes. Knurling upon the perimeter of the upper portion aids the user. An internal seal also excludes atmospheric communication to reduce spoilage of fluids within a container.

### CROSS REFERENCE TO RELATED APPLICATIONS

This continuation in part non-provisional application is filed in response to a petition to revive application Ser. No. 09/288,739 and claims priority to the continuation in part application Ser. No. 09/288,739 filed Apr. 7, 1999 under petition for revival, which claims priority to the continuation in part application Ser. No. 09/284,345 filed Mar. 4, 1998, now abandoned, and the continuation in part application Ser. No. 09/537,163 filed Mar. 27, 2000 which has been merged into the continuation in part application Ser. No. 09/288,739 which claims priority to the non-provisional application Ser. No. 09/034,757 filed Mar. 4, 1998, now abandoned and this non-provisional application claims priority to the non-provisional application Ser. No. 11/402,673 filed Apr. 13, 2006, now abandoned.

### BACKGROUND OF THE INVENTION

The flow limiting bottle cap relates to closures of beverage containers and more specifically to a cap having a pattern of holes therein reducing flow volume of a liquid poured through the cap.

From earliest days, people have needed to quench thirst. After drinking and collecting water from surface locations, people developed containers of various kinds. The containers generally had one opening for filling and drinking of fluids within the container.

One such container includes the one gallon milk jug used in homes nationwide. This jug has a rectangular base with rounded corners and then a somewhat rounded three sided pyramidal top portion. Opposite the top portion, a handle allows a person to grip the container. The handle and top portion join at a shoulder denoting the uppermost and narrowest portion of the container. The shoulder has a generally smooth, partially spherical form with the remainder of the container locating beneath it. The shoulder has a neck with an opening therethrough and threading upon the exterior of the neck for receiving a cap.

The inventor has experienced and witnessed over the years, that when pouring a liquid from the typical milk jug, the milk has gushed outwardly in a wide, single stream. Quick holders of a milk jug detect the onset of a milk gusher and correct the angle of pour in time. However, others suffer a preventable spill of milk.

### DESCRIPTION OF THE PRIOR ART

Other containers, such as water bottles, often have a push pull type cap. This cap provides an aperture, sometimes a ring shape, that causes a single stream of fluid to exit a container. A user may compress the container to accelerate the stream. However, these push pull caps permit a gush of fluid to exit the container with the risk of spillage for the unwary.

Other devices have sought to regulate the flow of fluid through a cap upon a container, generally for beverages. The Japanese patent to Omi, No. 10-167309, describes a push/pull type cap with an over cap extending from a composite cap that mounts to the mouth of a container. Omi describes a ceiling wall that retains fluid within the container. The ceiling wall has polygonal scoring, here octagonal. A breaking protrusion from the over cap breaks the scoring, into triangular shaped pieces that deflect like a hinge. The triangular shaped pieces provide additional edges that must be sealed to prevent leaks. The breaking protrusion enters the composite cap when the cap is closed and when the cap opens in the second position, fluid is removed from the cap. The remaining piece 10c serves as a hinged flap in regulating the flow of fluid through the cap. The remaining pieces attain a flat orientation with the breaking protrusion removed.

On the other hand, the present invention has a membrane with a central orifice that admits fluids therethrough. The orifice remains open in the absence of the truncated cone. The round orifice has the minimum perimeter for a given surface area thus minimizing the risk of leaks. The orifice becomes closed as the truncated cone fits into it. The orifice retains its round shape as the truncated cone stretches the membrane slightly. The membrane generally retains its planar orientation and does not have hinged parts or subparts that move under the action of the truncated cone.

The present invention overcomes the difficulties of the prior art as described above. That is, the prior art has a push pull cap with a central orifice. The prior art orifice has a hexagonal outer perimeter and triangular shaped pieces as hinged flaps. The central orifice allows for continuous flow from a round opening. The present invention though reduces the onset of a sudden gush of fluid poured from a container regardless of the angle of the container. This invention operates upon milk, juice, water based beverages, and alcoholic beverages. Though containers for beverages are described, containers of other fluids where a gush of fluid causes difficulties are also foreseen.

### SUMMARY OF THE INVENTION

Generally, the present invention is a two-piece bottle cap designed to fit a milk or other beverage container. The cap includes two portions and easily attaches upon the existing external threads of the container following removal of the manufacturer's cap. The cap of this invention substitutes for the manufacturer's cap and allows for reuse of the original cap if desired. The cap of the invention has a quick sealing feature from a truncated conical member inserted into a circular hole in a semi-flexible membrane.

There has thus been outlined, rather broadly, the more important features of the invention in order that the detailed description thereof that follows may be better understood and that the present contribution to the art may be better appreciated. The present invention also includes usage upon watering cans, a pattern of holes guiding the flow of fluid through the cap, and a plunger seating in the orifice blocking flow out of the cap during non-usage. Additional features of the invention will be described hereinafter and which will form the subject matter of the claims attached.

Numerous objects, features and advantages of the present invention will be readily apparent to those of ordinary skill in the art upon a reading of the following detailed description of the presently preferred, but nonetheless illustrative, embodiment of the present invention when taken in conjunction with the accompanying drawings. Before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, the phraseology and terminology employed herein are for the purpose of description and should not be regarded as limiting.

One object of the present invention is to provide a new and improved flow limiting bottle cap.

Another object is to provide such a cap that provides for a constant flow through the cap regardless of the angle of the fluid container to which the cap connects.

Another object is to provide such a cap that has a low cost of manufacture with regard to both materials and labor, and which accordingly then has a low sale price to the consuming public and more economically available to the buying public.

The above and further objects and novel features of the invention will be more fully apparent from the following detailed description when the same is read in connection with the accompanying drawings.

These together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated a preferred embodiment of the invention.

### BRIEF DESCRIPTION OF THE DRAWINGS

In referring to the drawings,

FIG. 1 illustrates the flow limiting bottle cap, in the open position, in a partially exploded view above the neck of a container;

FIG. 2 is an enlarged, partially sectional view of the cap showing the plunger occupying the orifice in the closed position;

FIG. 3 is an enlarged, partially sectional view of the cap showing the plunger away from the orifice in the open position; and,

FIG. 4 is a top view of the cap showing a pattern of holes.

The same reference numerals refer to the same parts throughout the various figures.

### DESCRIPTION OF THE PREFERRED EMBODIMENT

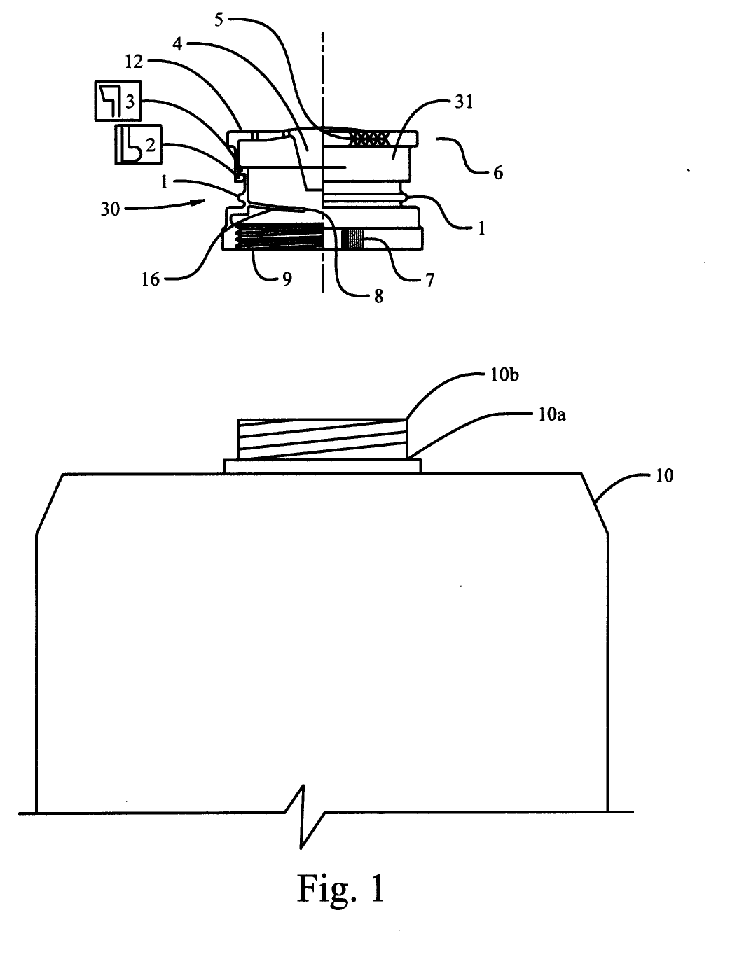

The present invention overcomes the prior art limitations and provides a flow limiting bottle cap for use upon beverage containers, primarily milk jugs. FIG. 1 shows the present invention ready for securement upon a container 10. The present invention connects to a neck 10a extending from the uppermost portion of the container. The neck has generally external threads as at 10b. The invention generally substitutes with the original closure cap found on either a half or a full gallon jug of milk in a plastic bottle. After purchasing the milk, the supplied cap and security seal, if present, are removed by the customer. The customer may or may not retain the supplied cap for reuse in the absence of the invention. The cap of the invention generally screws upon the external threads, as at 10b, upon the beverage container in place of the original cap.

The cap has a lower portion 30 and a concentric upper portion 31. The lower portion engages the neck 10a of the container and the upper portion allows for opening the cap and passage of fluid therethrough. The upper portion is generally outwardly from the lower portion. The lower portion is generally cylindrical with a continuous raised rib 1 molded into the perimeter. The rib extends outwardly and generally has a semi-circular cross section. Above the raised rib, the lower portion has an upper edge 3 upon the perimeter also extending outwardly. As shown in the detail, the upper edge may have a generally trapezoidal cross section. Generally below the rib 1 and within the lower portion, the cap has a membrane 16. The membrane extends inwardly from the perimeter and has a central round orifice 8. The membrane is generally semi-rigid and continuous around the inside of the lower portion and has a slight angle towards the lower portion. Beneath the membrane, the lower portion has internal threading, as at 9, that cooperates with the external threads 10b upon the neck 10a of the container. Upon the outer perimeter of the lower portion and generally outside the threads, the lower portion has a pattern of knurling, here shown as vertical lines 7, that aids a user in rotating the cap onto the neck.

The upper portion 31 also has a generally hollow cylindrical shape but with one end closed. Upon the perimeter of the upper portion, the upper portion has a second rib 2 having a semi-circular cross section and generally extending inwardly. The second rib abuts the upper edge 3 when the cap is in the open position and abuts the rib 1 when the cap is closed as later described. The second rib extends from the lower edge of a wall 27 generally in cylindrical form. The wall extends away from the upper edge to the plate 12. The plate spans across the width of the upper portion 31. Depending from the center of the plate, the plunger 4 extends beyond the height of the upper portion 31 towards the lower portion. The plunger generally fits snugly within the orifice 8 of the membrane 16 when the cap is in the closed position. The snug fit of the plunger 4 into the orifice 8 prevents fluid from exiting the cap of the invention. The wall 27 generally is perpendicular to the plane of the plate. Upon the outside of the wall proximate the plate, the upper portion 31 has a knurling pattern here shown as 5 in a diamond pattern that aids a person in gripping the upper portion during rotation.

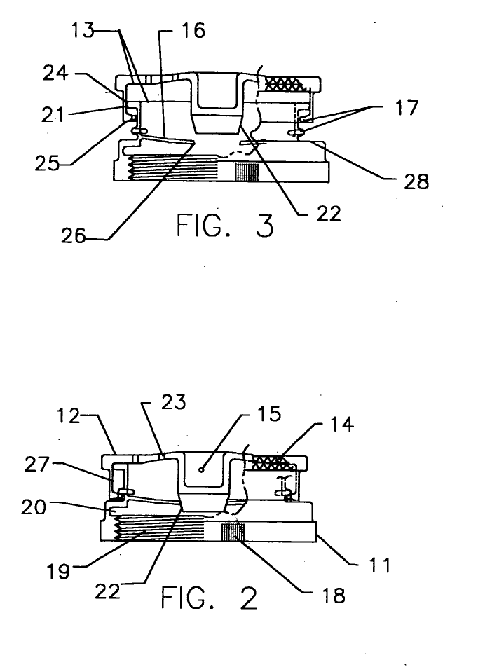

The cap occupies the closed position shown in FIG. 2 where the cap seals upon the container in several ways. The internal protruding member, or plunger 4, has a truncated conical surface or tip 22, opposite the plate 12, which closes the membrane 16 which contains an interference fit hole in it when the upper portion 31 of the cap is closed upon the lower portion 30 whether the locking thread segments 17—the rib 1 and the second rib 2—are engaged or disengaged, then the upper cap member is raised so the conical surface 22 escapes the membrane 16 opening the orifice 8. When the container is tipped, the fluid flows only through the hole pattern 23 in a plate 12 of the upper portion. A partial sealing feature is established by the ring 21, or second rib 2, and a smooth radius 24 of the upper edge 3 that blends with the smooth surface 13 of the wall 27 of the upper portion of the cap of this invention. This ring 21 has a light sliding fit against the cylindrical vertical surface of the wall in the lower portion. The plunger 4 may take various forms subject to manufacturing constraints, including weight savings provided by a cylindrical void 15 in the center of the plunger. This void illustrates an option for manufacture of material savings or weight savings.

Another sealing feature takes place when the cap opens as in FIG. 3. This sealing feature locks the cap into position and prevents inadvertent rotation. This sealing feature has three segments 17 of a screw type thread similar to that used on the base and socket of incandescent light bulbs, referred to as “Threads for Screw Shells of Electric Sockets and Lamp Bases-American Standard” as described in the “Machinist's Handbook”. The upper portion 31 has elements of this thread type as seen and used on commercial light bulbs, generally an external thread. The lower portion 30 has cooperating elements of this type thread as seen and used on commercial light bulbs, generally an internal thread, as in the socket for a bulb. The design in the cap of the present invention uses only short segments of these threads 17 where each segment occupies approximately forty five degrees of arc about the center of the lower portion, and each segment is also spaced at about one hundred twenty degrees radially in the upper portion and the lower portion. The axial location of the segments 17 on the upper cap member is at a point where the lowest end of the segment is adjacent to the lowest extreme of the second rib as at 25 and the thread segments 17 on the upper portion in such a way that the upper extreme edge, as at 13, of the lower portion 30 contacts the interior surface of the plate 12 and at the same time the lowest extreme of the second rib as at 25 does not contact the intermediate surface 28 of the lower portion. The intermediate surface is generally parallel to the top of the container. As mentioned above, closing and locking the upper portion and the lower portion engages the conical surface 22 of the plunger 4 into the orifice 8 of the membrane member 16.

To begin usage of the invention, referring to FIGS. 1, 2, the cap has internal threads 19 which cooperate with the external threads of a conventional plastic milk bottle of a half or one gallon capacity. The cap installs on the neck 10a of the bottle by turning the lower portion 30 upon the threads 10b, similar to a nut on a bolt. The knurling, as at 7, 18, enhanced the turning of the cap by aiding the fingers of a user to grip the raised diameter 11 at the bottom of the lower portion 30 of the cap. The cap may be installed on the container in either the closed or the open position.

Then during usage of the container having the invention installed, the user can turn the cap, particularly the upper portion 31 as need. If the upper portion of the invention is in the open, or pouring configuration, as in FIG. 3, pushing it down and rotating it a quarter turn clockwise, when looking at the upper portion, will seal it in the closed position as shown in FIG. 2. If the user wants to pour fluid from the container, reversing the previous steps opens the cap. The fluid flow is then controlled by a typical hole pattern 23 in the plate 12 when the container is tipped by the user.

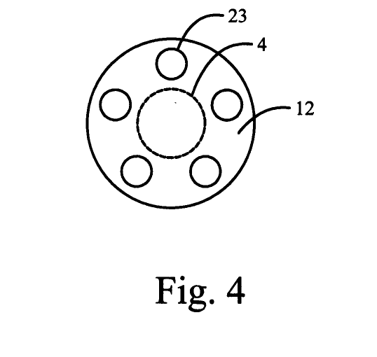

And, FIG. 4 shows a hole pattern in the upper cap member. This figure shows five holes though the number may vary to suit an application. The preferred arrangement of the hole pattern meets the flow characteristics of the fluid and whether it is to be poured narrowly in a single stream, in a plurality of streams, or a wide stream. In these pour conditions, the total area of the holes in the pattern 23 in the plate 12 cap shall not exceed seventy five percent, preferably sixty five to seventy percent, of the area of the orifice 26 in the membrane member. This ratio establishes the liquid having a head value to assure proper flow through the holes without an abrupt gush of fluid. This ratio can be calculated from the following formula:

$${d}_{i} \approx {d}_{o} \sqrt{\frac{a}{N}}$$

where dᵢ is the hole 23 diameter, dₒ is the orifice 26 diameter, a is the desired area ratio of dᵢ to dₒ and N is the number of holes.

From the aforementioned description, a flow limiting bottle cap has been described. The cap is uniquely capable of regulating the flow of a poured fluid from a beverage container to avoid an abrupt gush of fluid. Though milk and juice containers have been described, the present invention also may apply to watering scans, pesticide sprayers, other gardening applications, and paint spraying. The material used to produce the cap should of a high quality, semi flexible, preferrably colored plastic and manufactured by injection molding in a steel die. The cap and its various components may be manufactured from many materials, including but not limited to, polymers, high density polyethylene, polypropylene, ferrous and non-ferrous metals, their alloys, and composites.

As such, those skilled in the art will appreciate that the conception, upon which this disclosure is based, may readily be utilized as a basis for the designing of other structures, methods and systems for carrying out the several purposes of the present invention. Therefore, the claims include such equivalent constructions insofar as they do not depart from the spirit and the scope of the present invention.

I claim:

1. A device limiting fluid flow from a container having a threaded neck, said device avoiding abrupt fluid gushing from said container during pouring, said device, comprising:
a lower portion having a generally cylindrical shape, a membrane spanning across said lower portion, said membrane having a centered round orifice, at least one first rib outwardly from said lower portion, at least one internal thread adapting to attach said device to said container wherein said device turns upon the threaded neck of the container, an intermediate surface generally outward from said membrane and generally parallel to the plane defined by the neck of the container, at least one external thread, and knurling upon the exterior of said lower portion;
an upper portion having a generally planar cap, a hollow cylindrical wall beneath said cap, at least one second rib outwardly upon said wall, said at least one second rib engaging said at least one first rib and connecting said upper portion to said lower portion, at least one thread upon the interior of said wall said at least one thread engaging said at least one external thread of said lower portion, a round plunger centered in said upper portion and within said wall and including a truncated conical tip fitting into said orifice upon closing said upper portion upon said lower portion, said upper portion closing upon said lower portion by rotation of said upper portion upon said lower portion and by pushing said upper portion upon said lower portion, said cylindrical wall having a pattern of knurling upon the exterior of said upper portion, said upper portion rotating coaxially upon said lower portion;
a pattern of spaced apart holes through said upper member combining to provide less than the area of said orifice, said holes providing passage of fluid upon said plunger exiting said orifice when said upper portion rises from said lower portion; and,
said device having a closed position with said upper portion being adjacent said lower portion and an opened position with said upper portion being outwardly from said lower portion.

2. The flow limiting device of claim 1 further comprising:
said pattern of spaced apart holes combining to provide approximately sixty five percent to approximately seventy five percent of the area of said orifice

3. The flow limiting device of claim 2 further comprising:
said pattern of spaced apart holes including circular holes.

4. The flow limiting device of claim 1 further comprising:
said lower portion including three external threads, each thread extending for approximately 45° of arc, and each thread being spaced approximately 120°; and,
said upper portion including three threads, each thread extending for approximately 45° of arc, and each thread being spaced approximately 120°, said threads meshing with said external threads for closing said upper portion upon said lower portion by rotation of said upper portion.

5. The flow limiting device of claim 1 further comprising:
said lower portion having an upper edge, generally parallel to and outwardly from said first rib; and,
said second rib abuts said upper edge when said device attains the open position and abuts said first rib when said device attains the closed position.

6. The flow limiting device of claim 1 further comprising:
said lower portion having vertical lines as knurling; and,
said upper portion having a diamond pattern as knurling.
